(19) United States
(12) Patent Application Publication
(10) Pub. No.: US 2019/0178354 A1
(43) Pub. Date: Jun. 13, 2019

(54) CHAIN TENSIONING IN A HYBRID DRIVE MODULE

(71) Applicant: BorgWarner Sweden AB, Landskrona (SE)

(72) Inventor: BRUCE CHURCHILL, GROTON, NY (US)

(21) Appl. No.: 16/327,536

(22) PCT Filed: Aug. 30, 2017
(86) PCT No.: PCT/EP2017/071803

§ 371 Date: Feb. 22, 2019

(30) Foreign Application Priority Data
Aug. 31, 2016 (SE) 1651167-7

(51) Int. Cl. F16H 7/14; B60K 6/485

(52) U.S. Cl. CPC F16H 7/14; B60K 2006/4833; B60K 6/485

(57) ABSTRACT

A method of performing regular maintenance in a hybrid drive module, comprising a housing (170) enclosing a continuous member drive (120) comprising a chain or a belt (126) connecting an electrical motor (110) with a crank shaft (22) of an associated internal combustion engine (20) via at least one coupling (130, 140), said electrical motor (110) being fastened with respect to the crank shaft (22) via fastening elements (111) wherein said method comprises: unfastening the electric motor (110) from said motor's (110) fastening elements (111); positioning the electric motor (110) such that the crankshaft (22) is a distance (d) from the electric motor (110) and such that tension in the chain or belt (126) is at or above a pre-specified level; and re-fastening fastening elements (111) such that the electric motor (110) is maintained at the distance (d) from the crankshaft (22).

### TECHNICAL FIELD

The present invention relates to a hybrid drive module, and in particular to adjustment and tensioning of a continuous member in such hybrid drive module.

### BACKGROUND

Hybrid powertrains for passenger cars are gaining interest and various solutions for such applications have been proposed during the recent years. Especially it has been suggested to provide the hybrid functionality as a separate module which is added to the existing powertrain. One example of an existing hybrid drive module includes a first sprocket which is intended to be connected to the crank shaft of the internal combustion engine indirectly via a dual mass flywheel and a disconnect clutch, and an electrical motor, preferably a 48V electrical motor, being drivingly connected to a second sprocket. The sprockets are connected by means of a belt, thus forming a belt drive, in order to allow for various driving modes such as pure electrical driving, recuperation, traction mode, and boost. In this prior art system the electrical motor, the flywheel, the clutch, and the belt drive are formed as a standalone module which can be added to an existing powertrain.

To maintain tension in the belt drive such that torque can be transmitted via the belt, a belt drive tensioning system is generally used. These systems are normally complex hydraulic or mechanical systems and therefore a simpler device and method for tensioning is desirable.

### SUMMARY

It is thus an object of the teachings herein to provide an improved hybrid drive module overcoming the disadvantages of prior art solutions.

According to a first aspect, a method of performing regular maintenance in a hybrid drive module is provided. The hybrid drive module comprises a housing enclosing a continuous member drive, such as a chain drive or a belt drive, and the continuous member drive comprises a chain or a belt connecting an electrical motor with a crank shaft of an associated internal combustion engine via at least one coupling. The electrical motor is fastened with respect to the crank shaft via fastening elements. The method comprises: unfastening the electric motor from said motor's fastening elements; positioning the electric motor such that the crankshaft is a distance from the electric motor and such that tension in the chain or belt is at or above a pre-specified level; and re-fastening fastening elements such that the electric motor is maintained at the distance from the crankshaft. The method allows tension to be maintained in the drive of the hybrid drive module without complex tensioning mechanisms.

The distance may be the straight-line distance between the rotating axes of a first sprocket arranged at a fixed position relative to the electrical motor and a second sprocket being arranged at a fixed position relative to the crank shaft.

In an embodiment a force is applied to the motor to position the motor and increase tension in the chain or belt. The force may be applied continuously during re-fastening. The application of the force to the motor, and not to the sprockets or to the chain/belt simplifies installation.

In a second aspect a hybrid drive module is provided. The hybrid drive module comprises a housing enclosing a continuous member drive which comprises a chain or belt connecting an electrical motor with a crank shaft of an associated internal combustion engine via at least one coupling. The electrical motor is fastened with respect to the crank shaft via fastening elements and the electric motor is configured to be repositionable such that tension in the chain or belt is increased.

In an embodiment of the hybrid drive module tension is achieved exclusively by positioning of the electrical motor with respect to the crank shaft.

In a third aspect a hybrid vehicle is provided. The hybrid vehicle comprises a hybrid drive module according to any of the disclosed embodiments.

### BRIEF DESCRIPTION OF THE DRAWINGS

Embodiments of the teachings herein will be described in further detail in the following with reference to the accompanying drawings which illustrate non-limiting examples on how the embodiments can be reduced into practice and in which:

FIG. 1 shows a schematic outline of a hybrid drive module according to an embodiment;

FIG. 2 is a cross-sectional view of parts of a hybrid drive module according to an embodiment;

FIG. 3 is a an isometric view of parts of a hybrid drive module according to an embodiment;

FIG. 4 is an isometric view of a cassette for closing the housing of a hybrid drive module according to an embodiment;

FIG. 5 is a cross-sectional view of parts of an electrical motor for use with a hybrid drive module according to an embodiment.

FIG. 6 is an isometric view of parts of a hybrid drive module comprising an electric motor according to an embodiment; and

FIG. 7 is a schematic outline of the electric motor and first and second sprockets.

### DETAILED DESCRIPTION

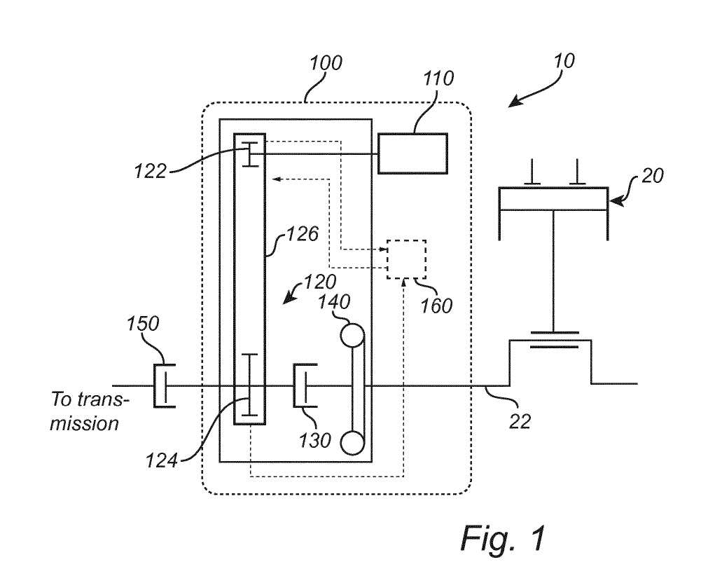

Starting in FIG. 1 a schematic layout of an engine assembly 10 of a vehicle is shown. The vehicle is typically a passenger car, and the engine assembly comprises an internal combustion engine 20 and a hybrid drive module 100 according to an embodiment. As will be explained in the following the hybrid drive module 100 is mechanically connected to a crankshaft 22 of the internal combustion engine 20 in order to provide additional drive torque to a transmission (not shown) arranged in series with the hybrid drive module 100. Hence, the transmission is also connected to the crank shaft 22 as is evident from FIG. 1.

The hybrid drive module 100 comprises an electrical motor 110 and a continuous member drive 120, here in the form of a chain drive, connecting the electrical motor 110 with the crank shaft 22. The electrical motor 110 is for this purpose driving a first sprocket 122 of the chain drive 120, whereby upon activation of the electrical motor 110 rotational movement of the first sprocket 122 is transmitted to a second sprocket 124 of the chain drive 120 via a chain 126.

The second sprocket 124 is drivingly connected to the crank shaft 22 via one or more couplings. In the embodiment shown in FIG. 1, the second sprocket 124 is connected to the output of a disconnect clutch 130 receiving driving torque from a dual mass flywheel 140. For parallel two-clutch systems, commonly denoted hybrid P2 systems, the disconnect clutch 130 is often referred to as the C0 clutch. The dual mass flywheel 140, which could be replaced by another torsional damping/absorption device, receives input torque directly from the crank shaft 22. However, for the purpose of the present embodiments either the disconnect clutch 130 and/or the dual mass flywheel 140 (or its substitute) could be omitted or replaced by another suitable coupling.

Also illustrated in FIG. 1 is a further optional clutch 150, here representing a launch clutch. Again referring to P2 systems, the launch clutch is often referred to as the C1 clutch. The launch clutch 150 is arranged downstream, i.e. on the output side of the hybrid drive module 100 upstream the transmission. It should be realized that the launch clutch 150 could be replaced by a torque converter or similar.

The electrical motor 110 is preferably a 48V motor/alternator which thus can be used to provide hybrid functionality to the existing powertrain of the vehicle. For other embodiments, also possible within the scope of this application, high voltage hybrid electrical motors may be utilized. More specifically, the provision of the chain drive 120 allows for modularity with high voltage hybrid electrical motors in comparison to if a belt drive would be used. A belt drive could never accommodate the much higher loads provided by a more powerful high voltage hybrid electrical motor.

The electric motor 110 is adjustable within the plane of the first and second sprockets 122, 124. Tension can be adjusted in the chain 126 by positioning of the electrical motor 110. In other words, tension in the chain drive 120 of the hybrid drive module 100 may be achieved exclusively by positioning of the electrical motor 110. As opposed to belt drive systems the chain drive 120 maintains sufficient tension for driving torque transfer to the electrical motor 110 and for driving torque transfer from the electrical motor 110 without chain tensioning components.

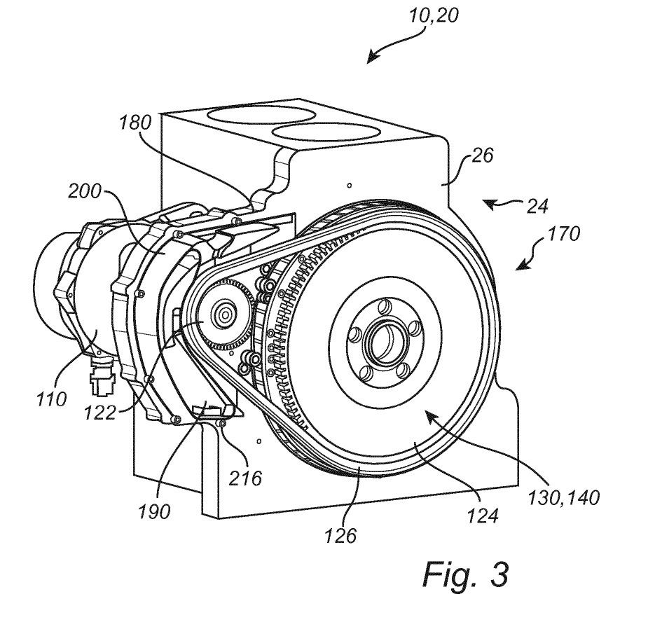

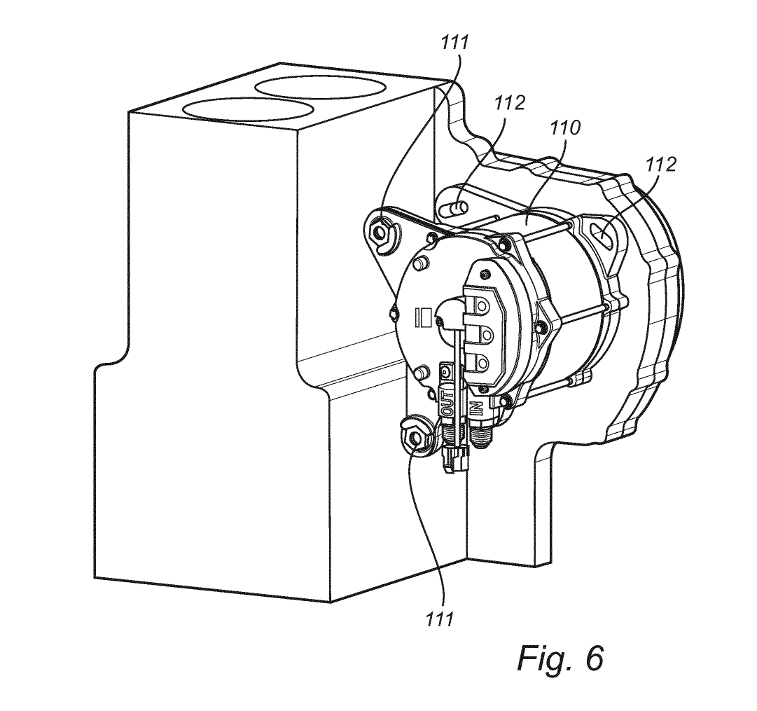

The electric motor 110, and hence first sprocket 122, can be positioned with respect to the second sprocket 124 via at least one fastening element 111 (see FIG. 6). The fastening element could, for example, be at least one bolt configured to pass through a hole in the casing of the electric motor 110. FIG. 6 shows a fastening element 111 for the electric motor 110 being two bolts provided in two holes provided in the casing of the electric motor 110. In FIG. 6 the casing of the electrical motor 110 comprising the holes extends orthogonally to the axis of rotation of the shaft of the electrical motor 110. In FIG. 6 the fastening elements 111 fix the motor to the engine block 10, 20, however, the fastening elements could also allow the motor to be fixed to the ear structure 180 as will be later explained with reference to FIG. 3. In FIG. 6. a second set of fastening elements 112 are shown. The second set of fastening elements 112 are two slots 112 provided in the casing of the electric motor 110. Each slot may be configured to receive a bolt or any other such means for fixing the electric motor 110 to the ear structure 180. The form of the slots allow the motor 110 to be moved in a pre-determined range of motion during fixing of the motor 110 to the ear structure 180 and/or the engine block 10, 20.

The first fastening elements 111 may for this purpose also comprise a slot extending in either the casing of the electric motor 110 or the engine block 10, 20 or the ear structure 180. The electric motor 110 is adjustable with respect to the second sprocket 124 such the distance between the first sprocket 122 and second sprocket 124 is adjustable. This is due to the fact that the position of the first sprocket 122 is fixed relative the electrical motor 110.

Through the combination of the chain drive 120 and the adjustable electric motor 110 the sprockets 122, 124 can remain reliably connected, even at high speeds and high torques, without the use of additional tensioning systems which are often heavy and expensive.

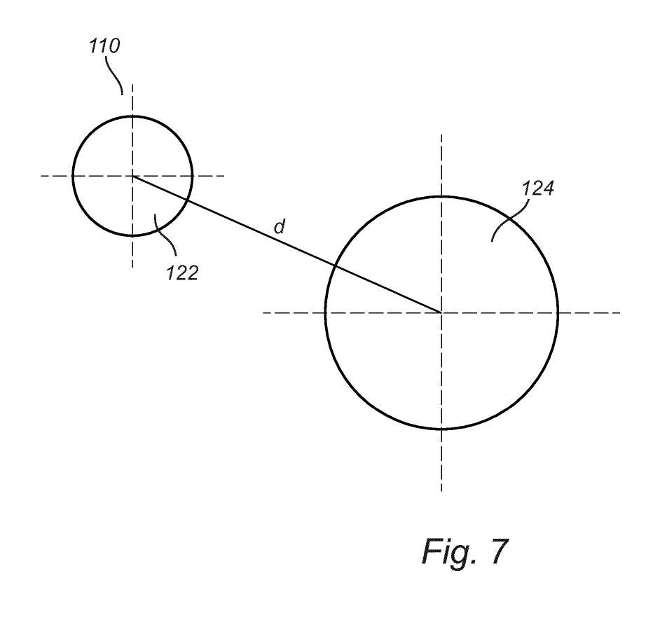

During long term operation, as is known to the person skilled in the art, the chain 126 may become elongated. A method for re-establishing tension in the elongated chain 126 is to unfasten the electric motor 110 from said motor's 110 fastening element 111, and to subsequently applying a force to the electric motor 110 such the motor 110 is repositioned. The electric motor 110 can be repositioned at a distance such that the first sprocket 122 is a greater distance d (see FIG. 7) from the second sprocket 124 and such that tension in the chain 126 is at or above a pre-specified level. After positioning, the fastening elements 111 can be re-fastened such that the electric motor 110 and first sprocket 122 are maintained at distance d from the second sprocket 124. During re-fastening a force may be continuously applied to the electric motor 110.

As shown in FIG. 7 the distance d is the straight-line distance d between the rotating axes of the first sprocket 122 and the second sprocket 124. When the fastening elements 111, 112 comprise slots the motor may be moved such that it is displaced along the length axis of the slots. An advantage of the above method and structure is that the first and second sprockets 122, 124, do not need to be adjusted individually to create tension in the chain 126. Furthermore, the chain itself 126 does not need to be adjusted.

The entire hybrid drive module 100 also comprises a lubrication system which according to the various embodiments presented herein is based on principle that the chain 126 will assist in circulating lubrication oil to the rotating parts of the hybrid drive module 100, i.e. the one or more couplings 130, 140. It should further be noted that in case of also utilizing a launch clutch or torque converter 150, this component could also be arranged within the hybrid drive module 100 thus taking benefit from the same lubrication system.

In some embodiments the lubrication system could be supported by an oil pump 160.

Lubrication oil should within the context of this disclosure be interpreted broadly to cover any automatic transmission fluid, engine oil, or other type of lubricating and cooling fluid suitable for the particular application.

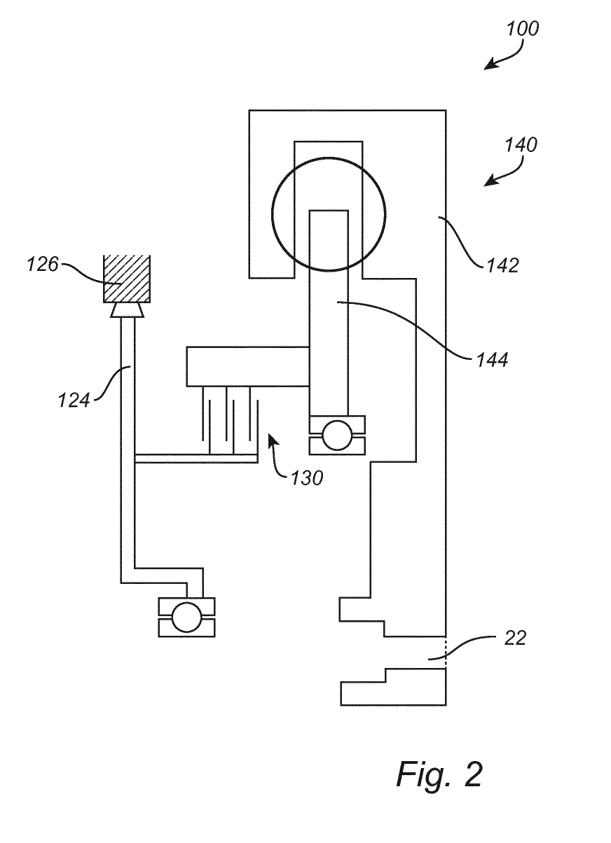

One major advantage of the proposed solution is the small amount of package space required. Now turning to FIG. 2 a cross-section of parts of the hybrid drive module 100 are shown, illustrating the compactness of the hybrid drive module 100.

The crank shaft 22 provides input torque to a primary inertial mass 142 of the dual mass flywheel 140. A secondary inertial mass 144 of the dual mass flywheel 140 is in turn connected to an input side of the disconnect clutch 130, here in the form of a limited slip coupling. The output side of the disconnect clutch 130 is connected to the second sprocket 124 carrying the chain 126. Preferably, one or more springs may be provided connecting the internal masses 142, 144 to each other such that the secondary inertial mass 144 may rotate relative the primary inertial mass 142 whereby the springs may deform causing a reduction of torsional vibrations being transmitted from the internal combustion engine 20.

The dual mass flywheel 140 and the disconnect clutch 130 are arranged concentrically around the crank shaft 22, thereby reducing the axial length of the hybrid drive module 100.

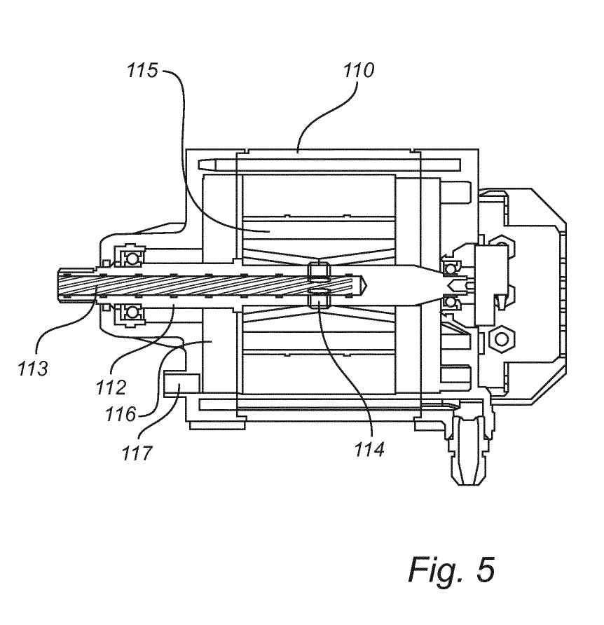

In FIG. 3 the engine assembly 10 is again shown. As can be seen the hybrid drive module 100 is enclosed in a housing 170. The housing 170 is formed by an end section 24 of an engine block 26 of the internal combustion engine 20, an ear structure 180 attached to the end section 24 and extending outwards from the engine block 26, and a cassette (see FIG. 5) sealing the housing 170. The ear structure 180 is provided to allow space for the electrical motor 110 and the first sprocket 122 of the chain assembly 120, while the dual mass flywheel 140, the disconnect clutch 130, and the second sprocket 124 are dimensioned to fit within a circular area within the end section 24.

The housing 170 forms a reservoir 190 by means of an insert 200 arranged within the ear structure 180, optionally extending into the circular area within the end section 24. The reservoir 190 is arranged to contain oil during operation, and to provide lubrication to the chain 126 during operation.

The provision of the reservoir 190 allows for a completely passive lubrication system, meaning that no external oil pumps or channels are required to provide sufficient lubrication to the rotating parts of the hybrid drive module 100. More specifically, during operation the chain 126 will throw oil at the upper end of the first sprocket 122, so that the oil will flow into the reservoir 190. When the oil level inside the reservoir reaches a certain height an outlet provided in the reservoir 190 will allow for oil to exit the reservoir 190 at a position where the chain 126 meets the first sprocket 122. By such configuration the chain 126 will be lubricated by its own motion.

The amount of oil which is not transported to the reservoir will eventually fall downwards to the bottom of the housing 170. Since the ear structure 180 is arranged at a vertical position slightly above the lowermost point of the circular area of the end section 26, the oil will end up in the lowermost region of the circular area where the second sprocket 124, the dual mass flywheel 140, the chain 126, and the disconnect clutch rotates. Hence, these rotating parts 124, 126, 130, 140, especially the primary inertial mass 142 of the dual mass flywheel 140, will pick up the oil and propel it around its perimeter. Optionally, the same oil may be passed through a circuit to the rotating parts for improved cooling and lubrication. Such circuit may e.g. include a heat exchanger for removing excessive heat from various components in the hybrid drive module 100.

Eventually, this oil will again flow into the reservoir 190. For this purpose the inlet of the reservoir 190 is dimensioned to receive oil primary from the chain, but also from the other rotating parts 130, 140.

A magnet 216 is preferably arranged at the bottom of the reservoir 190 in order to attract any metal particles contained within the oil. Optionally the magnet 216 may be replaced by or in combination with a filter or other suitable means for cleaning the lubrication fluid during operation.

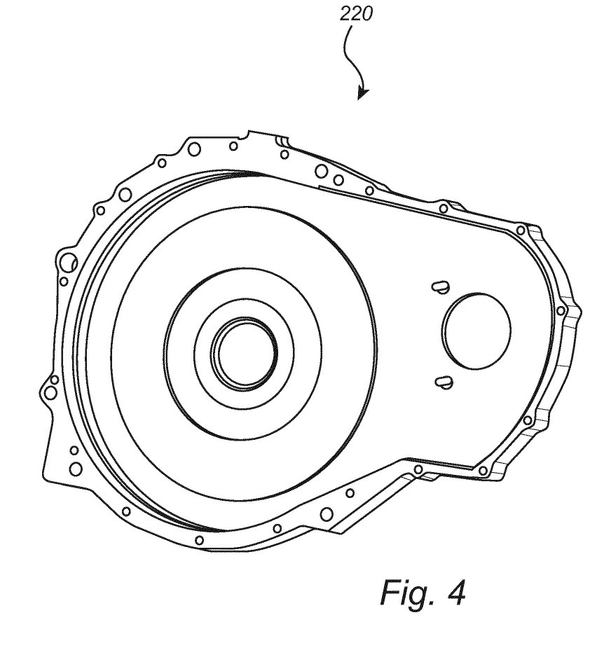

Now turning to FIG. 4 a cassette 220 is shown. The cassette 220 forms a closure for the housing 170 and the cassette 220 is thus dimensioned to fit with the entire housing 170, i.e. the end section 24 of the engine block 26 and the ear structure 180 attached thereto. The purpose of the cassette 220 is consequently to provide a sealed closure for the hybrid drive assembly 100.

The embodiments presented above all share the same technical concept of utilizing a passive lubrication system for an entire hybrid drive module 100 using a chain drive 120 and a reservoir 190 by which lubrication oil may be circulated within the hybrid drive module 100.

In FIG. 5 an embodiment of the electrical motor 110 is shown. In this example the electrical motor 110 is configured not only to receive oil from the reservoir 190 for cooling and lubrication of the electrical motor 110, but also to act as a pump in combination with the chain drive 120 for the entire lubrication system of the hybrid drive module 100.

In particular, the rotational shaft 112 of the electrical motor 110 is provided with an axial inlet for receiving oil from the reservoir 190. A passageway 113 inside the rotational shaft 112 transports the oil until it reaches one or more radial drillings 114, where the oil exits and hits the rotor assembly 115. As the rotor assembly is rotating, it will pull oil out of the shaft 112, pass it across the rotor assembly 115, and fling oil onto the end turns 116. The coolant oil could optionally pass onto a heat exchanger used for the electronics to extract heat.

With the outlet holes 114 on the rotor assembly 115 at a radial distance from the center line of the shaft 112, this will create a pumping action to pull the oil through. The oil could then drain back into the cassette 220 to be recirculated again.

An oil cooled motor 110 will allow for a much higher continuous performance level compared to a water cooled electric motor. This is due to the fact that the oil coolant is applied directly to the hot parts of the electric machine, i.e. the copper end-turns in the stator and onto the rotor assembly to cool the magnets.

Although the above description relates mainly to chain drives, it should be realized that the concept of adjustment and tensioning could be applied for other continuous member drives, such as belt drives.

It should be mentioned that the improved concept is by no means limited to the embodiments described herein, and several modifications are feasible without departing from the scope of the appended claims.

1. A method of performing regular maintenance in a hybrid drive module, comprising a housing enclosing a continuous member drive comprising a chain or a belt connecting an electrical motor with a crank shaft of an associated internal combustion engine via at least one coupling, said electrical motor being fastened with respect to the crank shaft via fastening elements wherein said method comprises:
unfastening the electric motor from said motor's fastening elements;
positioning the electric motor such that the crankshaft is a distance (d) from the electric motor and such that tension in the chain or belt is at or above a pre-specified level; and
re-fastening fastening elements such that the electric motor is maintained at the distance (d) from the crankshaft.

2. The method according to claim 1 wherein the distance (d) is the straight-line distance between the rotating axes of a first sprocket being arranged at a fixed position relative to the electrical motor and a second sprocket being arranged at a fixed position relative to the crank shaft.

3. The method according to claim 1 wherein a force is applied to the motor to position the motor and increase tension in the chain or belt.

4. The method according to claim 1 wherein the force is applied continuously during re-fastening.

5. A hybrid drive module, comprising a housing enclosing a continuous member drive comprising a chain or a belt connecting an electrical motor with a crank shaft of an associated internal combustion engine via at least one coupling, said electrical motor being fastened with respect to the crank shaft via fastening elements wherein said motor is configured to be repositionable such that tension in the chain or belt is increased.

6. The hybrid drive module according to claim 5 wherein tension is achieved exclusively by positioning of the electrical motor with respect to the crank shaft.

7. A hybrid vehicle, comprising a hybrid drive module comprising a housing enclosing a continuous member drive comprising a chain or a belt connecting an electrical motor with a crank shaft of an associated internal combustion engine via at least one coupling, said electrical motor being fastened with respect to the crank shaft via fastening elements wherein said motor is configured to be repositionable such that tension in the chain or belt is increased.

8. The hybrid drive module according to claim 7 wherein tension is achieved exclusively by positioning of the electrical motor with respect to the crank shaft.

9. The method according to claim 2 wherein a force is applied to the motor to position the motor and increase tension in the chain or belt.

10. The method according to claim 2 wherein the force is applied continuously during re-fastening.

11. The method according to claim 3 wherein the force is applied continuously during re-fastening.
